(19) United States
(12) Patent Application Publication
(10) Pub. No.: US 2011/0276444 A1
(43) Pub. Date: Nov. 10, 2011

(54) METHOD AND DEVICES FOR SERVICE RATING

(76) Inventor: Robert Törnkvist, Karlshamn (SE)

(21) Appl. No.: 13/143,682

(22) PCT Filed: Jan. 27, 2009
(86) PCT No.: PCT/EP2009/050873

§ 371 Date: Jul. 7, 2011

(51) Int. Cl. H04L 12/14; H04M 15/00

(52) U.S. Cl. 705/32

(57) ABSTRACT

A method of service rating in a service providing network is described. The method comprises: —a service entity performing (S10) a service provision action towards a user, —said service entity sending (S11) a rating trigger message to a rating entity, —said rating entity determining from said rating trigger message a reference to service related information related to said service provision action, and sending (S12) a request for service related information to a dedicated agent entity of said service providing network, said request comprising said reference, —said dedicated agent entity performing (S13) a data procurement operation towards a destination entity on the basis of said reference, —said destination entity sending (S14) response data to said dedicated agent entity, —said dedicated agent entity extracting (S15) one or more pieces of information from said response data and sending said one or more pieces of information to said rating entity as a response to said request for service related information.

### FIELD OF THE INVENTION

The present application relates to a method of service rating in a service providing network, to an agent entity and a rating entity involved in such a method, and to methods of controlling such a rating entity and an agent entity.

### BACKGROUND

In the field of communications it is well known to arrange service providing networks, i.e. networks that comprise different entities for providing a predetermined service to a user of the network. Such a service providing network can e.g. be a telephone network for providing telephone services, or a network for conveying certain types of data to users, e.g. a network for providing television services, such as IP TV or mobile TV.

In general, there is a desire to charge users for usage of a particular service. For this purpose, it is known to implement specialized entities in service providing networks that can perform a so-called rating operation, i.e. that can perform a cost calculation as a basis for a billing operation, i.e. charge an account or make an itemized bill. Such systems are sometimes referred to as charging systems. In such networks an entity providing the service (e.g. a server arranged to provide specific data to users upon request) will send information relating to the service provision to the charging system, e.g. to a rating entity that performs a cost calculation on the basis of the information provided by the service entity.

Several protocols exist for transferring information from a service entity to an entity that can perform the rating. Current protocols, such as Diameter, are easily extendable with new information that can be used for the rating operation. The charging systems that perform rating based on specific received information have to be able to decode the received information, and therefore the meaning and format of the information sent to the rating entity has to be known and defined.

The service entity that provides service to users is arranged to select what information should be sent to the charging system for rating. This selection is generally based on what the service entity deems as necessary/essential for the rating operation. Such a selection operation is due to a number of reasons, for example it would be impractical to send all possible information; the charging system will generally be unaware of what information may be available at the service entity at the time that the service entity sends its charging or rating trigger message; and if the service entity only sends information after the service has been provided/delivered, the charging system is not in a position to influence what information has been collected.

In some systems, more than one entity is involved in the provision of a service. For example, in multimedia services, such as television over IP or mobile TV, one entity may provide a program guide and another may provide the actual television programs. In such systems it is preferable that one entity collects the information to be used for the rating procedure. The reason for this is that correlating information from different entities for the same service provision is difficult in real-time. Even for non-real-time procedures, there are limitations and complications due to the necessity of providing information for correlation.

FIG. 7 is a schematic representation of a service providing network in which one of the service entities collects and decides on when and what to charge for, and the charging system then provides rating and charging on the basis of the information selected by the service entity.

FIG. 7 can for example relate to a TV scenario, in which reference numeral 71 describes a service entity SE that provides a program guide and reference numeral 73 refers to a second service entity SE that provides the actual channels. In other words, service entity 71 provides information about TV programs in a suitable format for a program guide application on the user side, whereas service entity 73 provides the actual program content, e.g. streams or download files of audio/video information. Reference numeral 72 relates to a resource entity RE that holds data accessible by service entity 1 for providing the program guide service, whereas reference numeral 74 describes a further resource entity RE that holds the actual program data (e.g. audio/video files) accessible by service entity 73. Thus service entity 71 can retrieve information from resource entity 72 and provide the information to a user. A user can then select one of the programs indicated in the program guide information, and is directed to service entity 72 (e.g. by a link in the program guide information) that will then access resource entity 74 to procure the actual program data. FIG. 7 furthermore shows a resource entity 75 that may be accessed by service entity 73 for the purpose of transcoding the program data from resource entity 74 before transmitting it to the user.

Reference numeral 70 relates to a rating entity RtE that can be part of a charging system. In the above example, service entity 73 may have received information from service entity 71, which may in turn have extracted some information from resource entity 72, and service entity 73 may also receive information from resource entities 74 and 75. Which information is selected and communicated by the individual entities is individually configured, depending on the system and the entity. Service entity 73 may then generally be arranged to send a rating trigger message to rating entity 70, where again a specific selection of information is made, which depends on the specific service, the individual configuration, the individual implementation and the protocols used between the different entities.

It can thus be seen that the process of performing a rating procedure is complicated in that each individual entity must be specifically configured to provide certain information elements. This leads to inflexibility, as changes must be implemented and configured in the complete network.

### SUMMARY

The object of the invention is to provide an improved method and architecture for performing a rating operation in a service providing network.

This object is achieved by the methods and entities of the independent claims. Advantageous embodiments are described in the dependent claims.

In accordance with the present invention, a dedicated agent entity AE is introduced in the service providing network, which is schematically shown as element 80 in FIG. 8, which otherwise is identical to previously described FIG. 7. The dedicated agent entity AE acts as a form of mediation entity between the charging system and other entities of the service providing network, in order to give the rating entity (e.g. element 70 in FIG. 8) a mechanism for procuring information that the rating entity desires for performing the rating procedure. For this purpose, a service entity that performs a service provision action towards a user includes information in a rating trigger message to a rating entity, which information allows the rating entity to determine from the rating trigger message a reference to service related information associated with the service provision action. For example, such a reference can be the address (e.g. Uniform Resource Locator URL) of a resource entity that provides content data for the service provision. The rating entity is then capable of sending a request for service related information to the dedicated agent entity, where the request comprises the reference. The dedicated agent entity can then provide a data procurement operation towards a destination entity (e.g. the resource entity in the just mentioned example) on the basis of the reference, such that the destination entity sends response data to the dedicated agent entity, which in turn can then extract one or more pieces of information from the response data and send the one or more pieces of information to the rating entity as a response to the request for service related information.

On account of the just described concept, the rating entity is put into a position of being able to obtain service related information, e.g. if the rating entity deems it desirable to obtain information not contained in the rating trigger message sent by the service entity. In this way, it is not necessary to implement complicated procedures in the service entities or resource entities for making selections of information to provide to the rating entity. Namely, the service entities and resource entities can provide information as deemed desirable by the operators of these entities, and the rating entity is nonetheless able to obtain desired information, even if this is not initially provided by the service/resource entities.

### BRIEF DESCRIPTION OF FIGURES

The concepts of the present invention will now be described by referring to detailed embodiments, which serve to give a better understanding of these concepts, but are not to be seen as limiting, by making reference to the attached figures, in which:

FIG. 1 shows a flow chart of a basic method embodiment of the present invention;

FIG. 2 shows a flow chart of a method for controlling an agent entity according to an embodiment of the invention;

FIG. 3 shows a flow chart of a method for controlling a rating entity according to an embodiment of the invention;

FIG. 4 shows a preferred embodiment of a method for controlling a rating entity;

FIG. 5 shows a schematic block diagram of an agent entity according to an embodiment of the invention;

FIG. 6 shows a schematic block diagram of a rating entity according to an embodiment of the invention;

FIG. 7 shows a schematic example of a service providing network;

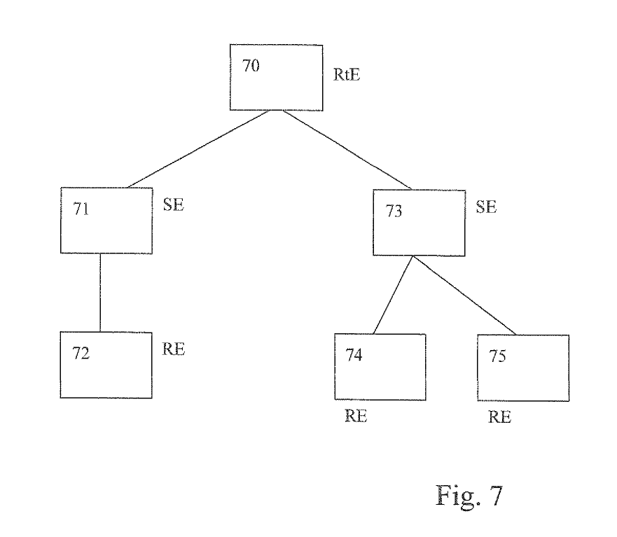

FIG. 8 shows a schematic block diagram of a service providing network comprising a dedicated agent entity; and

FIG. 9 shows a schematic representation of operations and signalling between entities of a service providing network according to an embodiment of the invention.

### DETAILED DESCRIPTION

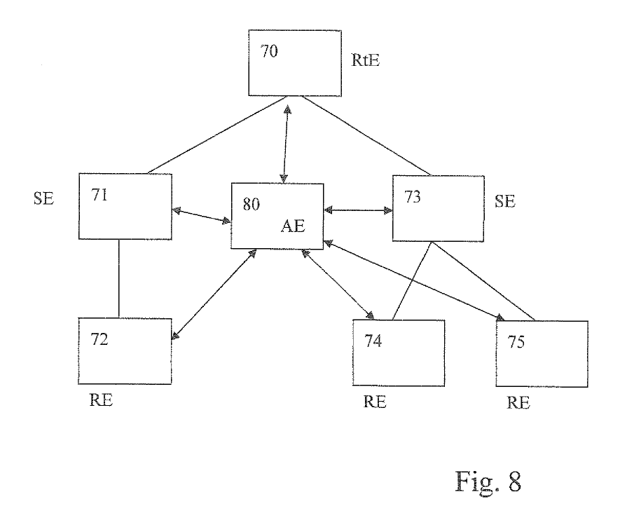

FIG. 8 shows an example of a service providing network using a dedicated agent entity (AE) 80 for improving the rating capabilities in the service providing network. It is noted that in the present application and claims the term entity is used generically to describe a device or group of devices that provide a given functionality. As such, an entity can be a single unit, such as a node or server, but can also be a group of devices that provide a functionality in a distributed manner.

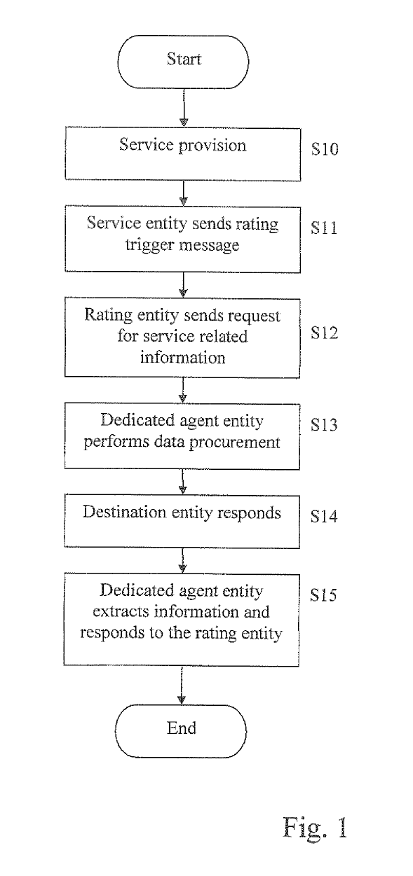

FIG. 1 shows a flow chart of a basic method embodiment applicable to the service providing network of FIG. 8. In step S10, a service entity (such as service entity 73 of FIG. 8) performs a service provision action towards a user. For example, service entity 73 can be a server for providing an IF TV or mobile TV program to a user. In step S11 the service entity 73 sends a rating trigger message to rating entity 70, which can e.g. be part of a charging system. The rating trigger message can be sent in any known way, e.g. prior to actually providing service, during the position of service, or after completion of service provision. In accordance with the invention, the rating trigger message is prepared in such a way that it comprises information allowing the rating entity 70 to determine a reference to service related information associated with the service provision action performed by the service entity 73. Consequently, the rating entity 70 then sends a request for service related information to the dedicated agent entity 80, where this request comprises the derived reference, see step S12 in FIG. 1. The indicated information can be provided in the rating trigger message in any suitable or desirable way, e.g. the reference can simply be explicitly contained therein. The reference itself can also be provided in any suitable or desirable way (e.g. it can be an address, of such as a URL or generally a Uniform Resource Indicator URI) that identifies a specific location and/or resource at that location, or it can be an indirect indication of a place for obtaining service related information, e.g. it can be information that identifies the service itself, which can in turn be used by the dedicated agent entity 80 for locating information related to that service.

In step S13 the dedicated agent entity 80 then performs a data procurement operation towards a destination entity on the basis of the reference. The destination entity can be selected in dependence on the nature of the reference. For example, if the reference directly identifies a source of information, e.g. is an address to a service entity or resource entity involved in the service in question, then the destination entity can be the entity identified by the address. In other words, the dedicated agent entity 80 can then perform a data procurement operation towards the address, e.g. in the example of FIG. 8 towards resource entity 74 that holds service content, such as for example audio/video files for downloading or streaming as a part of an IP or mobile TV service. However, if the reference is only indirect, e.g. identifies the service but not specific entities involved in the service, then the destination entity could be an entity that acts as a repository for service related information and associates this information with identified services.

In step S14 of FIG. 1, the destination entity in question sends response data to the dedicated agent entity 80, and in step S15 the dedicated agent entity 80 extracts one or more pieces of information from the response data and sends the one or more pieces of information to the rating entity 70 as a response to the request for service related information.

The process of extracting pieces of information from the procured data can be done in any suitable or desirable way. For example, this may consist in parsing a file of a given format for a predetermined type of information, e.g. to be found in an identifiable field of that file. As an example, the response data from the destination entity could be an HTML (Hypertext Markup Language) or XML (eXtended Markup Language) file having specific fields, and the extracting operation can comprise extracting the content of one or more fields that were e.g. identified in the request for service related information sent by the rating entity.

It is important to note, however, that the concept of the invention does not require that the rating entity has specific knowledge of the kind of information or format of information in the response data provided by the destination entity. Namely, it is a specific advantage of the invention that the designated agent entity has a mediating role, and may thus be able to process requests for information that the destination entity would not understand (e.g. due to a lack of compatible formats and/or protocols), and equally it is possible that the destination entity provides response data that does not contain the specific information requested by the rating entity. It is thus understandable that the dedicated agent entity could also respond to the request for service related information from the rating entity by indicating that the desired information is not available.

In the given example, it is possible that the rating entity 70 desires to know the name of the producer of a specific television program that is being delivered to a user as a service provision action by the service entity. For example, this could be desirable, as a specific producer might offer specific discounts over a given network, e.g. a predetermined mobile TV network. In this case, the rating entity could send a request for service related information in a suitable format to dedicated agent entity 80, which is arranged to understand and interpret the message in the given format. This message would contain the request for the name of the producer in the present example. Furthermore, the message contains the reference, e.g. the URL of the resource entity 74 holding the TV program files. According to the invention, the dedicated agent entity 80 is arranged to query resource entity 74 in an appropriate way, i.e. is able to communicate in a protocol and format understandable to the resource entity 74. If the response data from resource entity 74 is e.g. a text based file, such as an HTML file containing description information of the TV program involved in the service provision action by the service entity 73, then dedicated agent entity 80 is arranged for parsing this file to look for information that identifies the producer. If such information can be extracted, it is provided to the rating entity 70; if no such information can be extracted, a corresponding failure message is sent to the rating entity 70.

According to a preferred example of the invention, the agent entity 80 is arranged in such a way that it can perform a form of translating operation, in order to translate information from one format into another. For example, the procured data may be of a first type, and the extracting operation may comprise generating the one or more pieces of information as data of a second type different from the first type. As an example, the data provided by the destination entity can be video information or pixel information (e.g. a video stream from the TV program, or a pixel image therefrom), and the dedicated agent entity 80 can have suitable recognition mechanisms (such as optical character recognition (OCR)) and analysing logic, in order to indentify desired information, such as the name of the producer.

As indicated previously, the reference may comprise an address such as a uniform resource locator (URL) associated with the destination entity. Furthermore, alternatively or in addition, it may comprise an indicator related to a resource associated with the service provision action, e.g. an identification of the service being provided in the service provision action, e.g. the name of the television program. However, the indicator may furthermore also comprise a validity indication or a version indication, in order to specifically pin-point the specific service provision action, and thus be able to obtain the desired information relating to that specific service provision action and not some other possibly similar service provision action.

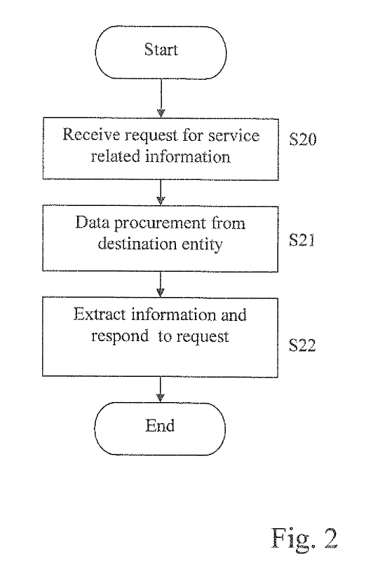

FIG. 2 shows a flow chart of a method for controlling an agent entity for a service providing network, such as agent entity 80 of FIG. 8. In step S20 a request for service related information is received from a rating entity, where the request comprises a reference relating to a service provision action. The service provision action can e.g. be the sending of a specific content to user, such as a specific TV program. Then, the agent entity is controlled to perform a data procurement operation towards a destination entity on the basis of the reference, see step S21. After having received procured data from the destination entity, the agent entity is controlled to extract one or more pieces of information from the procured data for sending to the rating entity in response to the request for service related information, see step S22.

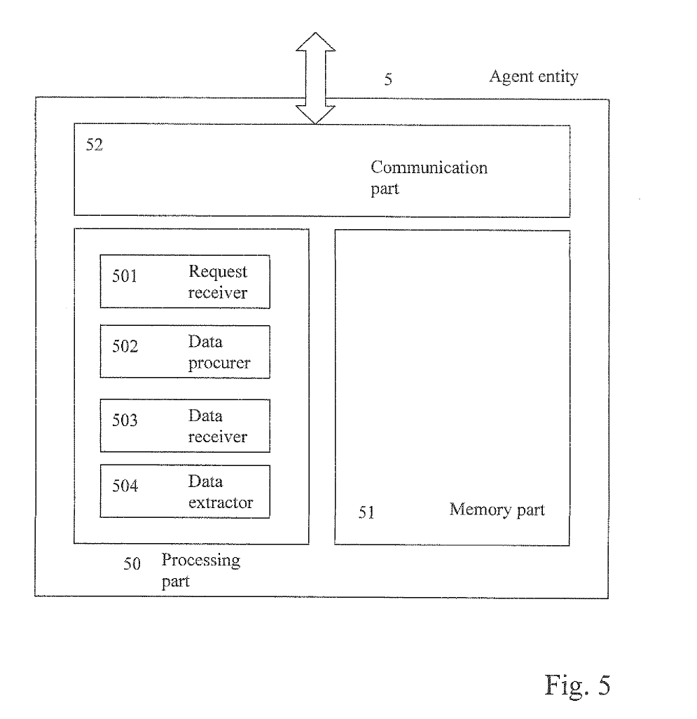

FIG. 5 shows a schematic example of an agent entity 5. The agent entity 5 comprises a processing part 50, a memory part 51 and a communication part 52. These elements are basically known for communication nodes or communication servers, such that a further description is not necessary here. In accordance with the embodiment of the invention, the agent entity 5 comprises a request receiver 501 for receiving a request for service related information from a rating entity (via communication part 52), the request comprising a reference relating to a service provision action, a data procurer 502 for performing a data procurement operation towards a destination entity on the basis of the reference, a data receiver 503 for receiving procured data from the destination entity (via communication part 52), and a data extractor 504 for extracting one or more pieces of information from the procured data for sending to the rating entity in response to the request for service related information. As can be seen, in the example of FIG. 5 the elements 501, 502, 503 and 504 are indicated as parts of the processing part 50. This is one possibility, namely processing part 50 may be a programmable processor, and correspondingly the request receiver 501, data procurer 502, data receiver 503 and data extractor 504 can be implemented as computer program parts in a computer program running on processing part 50. However, it is noted that the elements 501, 502, 503 and 504 can be provided as hardware, software or any suitable combination of hardware and software.

As already mentioned, the concept of the invention can be applied to service providing networks comprising service entities and resource entities. The service entities may be arranged for procuring resources (such as files) from said resource entities for providing service to users. A predetermined interface protocol can thus be defined between the service entities and resource entities. In an example of the invention the destination entity can be such a resource entity. A preferred embodiment of the invention in then such that the data procurement operation performed by the agent entity is such that it uses the predetermined interface protocol for accessing the destination entity. This provides the distinct advantage that the resource entities do not need to be modified for implementing the concepts of the present invention, as the dedicated agent entity communicates with the resource entities like the service entities communicate with the resource entities.

According to a further embodiment, in case that the service entities are arranged for communicating with the rating entity according to a second predetermined interface protocol, different form the first interface protocol for use between the service entities and resource entities, then the communication between the agent entity and the rating entity is preferably performed according to the second predetermined interface protocol. The advantage of this feature is that the rating entity then does not need to be modified with respect to the communication protocols of communication rules that it uses towards other entities.

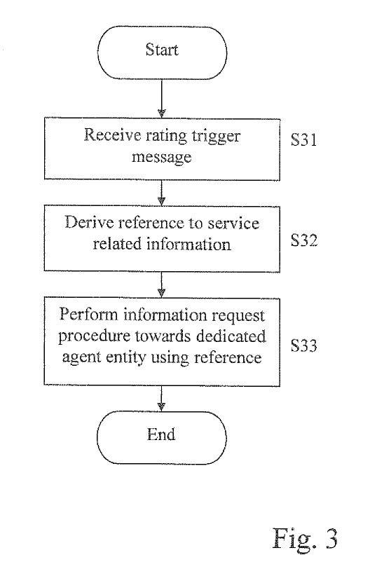

FIG. 3 shows a flow chart of a method of controlling a rating entity for a service providing network according to an embodiment of the present invention. In step S31, a rating trigger message is received from a service entity, which triggers a procedure for performing a rating operation. Then, in step S32 a procedure is performed for determining from the rating trigger message a reference to service related information related to a service for which the rating procedure is to be performed. Finally, in step S33 an information request procedure is performed for procuring desired information on the basis of the reference, where the request procedure comprises sending a request for service related information to the dedicated agent entity.

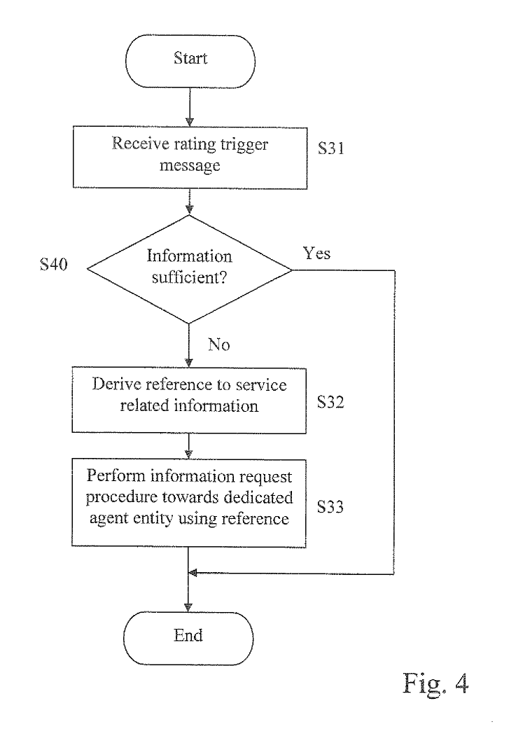

FIG. 4 shows a preferred embodiment of the method basically described in FIG. 3, which furthermore comprises a procedure for determining whether first service related information that is present at the rating entity is sufficient for the rating operation, and if the first service related information is determined to insufficient, performing the information request procedure for procuring the desired information as second service related information. More specifically, steps S31, S32 and S33 in FIG. 4 are like in the example of FIG. 3, such that a further description is not necessary. However, following step S31, the method of FIG. 4 has step S40, in which it is determined whether the information present at the rating entity is sufficient for the rating operation. If yes, then the procedure ends, if no the procedure performs steps S32 and S33. It is noted that in a further example, the rating entity may be arranged to repeat a step like S40 after step S33, i.e. to again determine whether the information present (e.g. received from the dedicated agent entity) is sufficient, and to possibly perform the information request procedure towards the agent entity again, preferably requesting different information than the previous time.

It is noted that the first service related information can be present due to a variety of reasons, e.g. the rating entity may have a list of certain service related information that contains static information on one or more services. However, usually the first service related information present at the rating entity will be taken from the rating trigger message, i.e. will be information provided to the rating entity by the service entity that sends the rating trigger message.

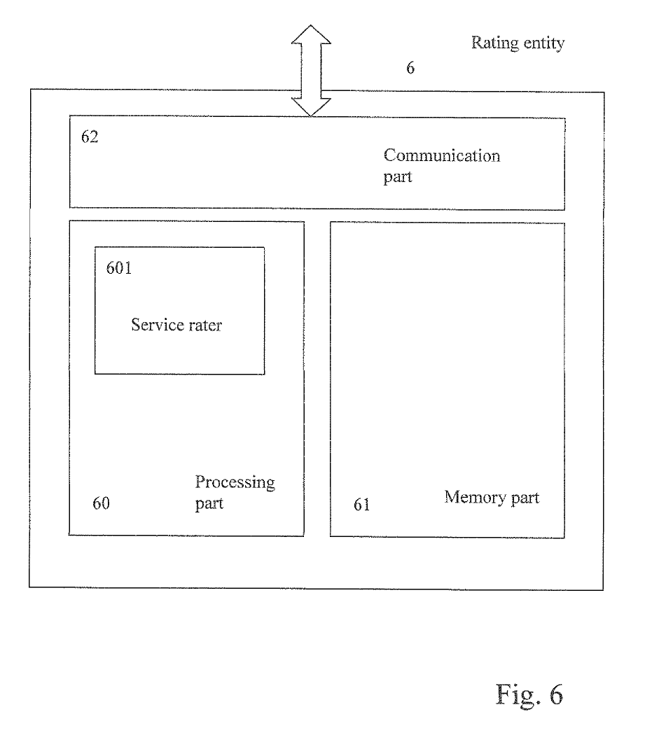

FIG. 6 shows a schematic block diagram of a rating entity arranged in accordance with the present invention. The rating entity 6 (e.g. a node or server within a communication network) comprises a processing part 60, a memory part 61 and a communication part 62 for receiving and sending messages to other entities of the communication network. As such elements are basically known, a further description is not necessary.

In accordance with the embodiment of the invention, a service rater 601 is provided for receiving a rating trigger message from a service entity (via the communication part 62) and performing a rating procedure in response thereto, where the service rater 601 is arranged to determine from the rating trigger message a reference to data related to service for which the rating procedure is to be performed, and to perform a request procedure for procuring desired information on the basis of that reference. The request procedure comprises sending a request for service related information to a dedicated agent entity of the service providing network.

Similar to the case of the agent entity of FIG. 5, the service rater 601 is shown as a software element implemented in the processing part 60. However, it is to be noted that this is only an example and the service rater can be provided as hardware, software or any suitable combination of hardware and software.

As can be seen from the preceding description of embodiments of the invention, the described concepts provide a more flexible selection of information to be used by the rating entity, e.g. only if the rating entity indeed deems it necessary to acquire more information than already present. This is done as a part of the rating procedure, as it is most advantageous that the rating entity determine whether or not further information is needed to continue the rating operation. This information does not have to be stored with the entity requesting the charging, i.e. sending the rating trigger message, as it is designed to provide information allowing the rating entity to derive a reference to where the desired information is stored. Making such information available for the rating/charging operation does not place supplementary requirements on the entity holding the information (e.g. a resource entity), except for the capability of sending the information that might be needed.

As already mentioned, this can in fact in a preferred embodiment be identical to the procedure of sending information to a service entity or to a user in response to standard requests for service provision. Namely, in this case the dedicated agent entity is capable of extracting the desired information from the normal data as usually provided by the resource entity to a service entity or user.

It is noted that the information stored in the destination entities, such as in the resource entities, is usually not formatted for direct interaction with a rating entity/charging system, as it has a different focus than rating, such that it will contain a lot of information that is not useable for rating or is not understood by the rating entity. However, this is not a problem, as the dedicated agent entity of the invention performs the suitable interfacing tasks between the destination entity and the rating entity. In other words, the dedicated agent entity will implement an appropriate mechanism for finding and selecting information, and possibly also for translating of information from the data response that it receives from the destination entity. As already mentioned, this finding, selecting and translating mechanism could be a simple downloading of a document (such as an XML or HTML document) that a given reference (like a link, URL) points to and then translate in a previously configured way, or could be more sophisticated, e.g. where the rating entity has mechanisms for performing selections and requests towards the resource holding the information. Since the data may be dynamic and dependent on the event that took place earlier (i.e. the service provision action), it is also possible to implement a type of validity indication or version handling of the information.

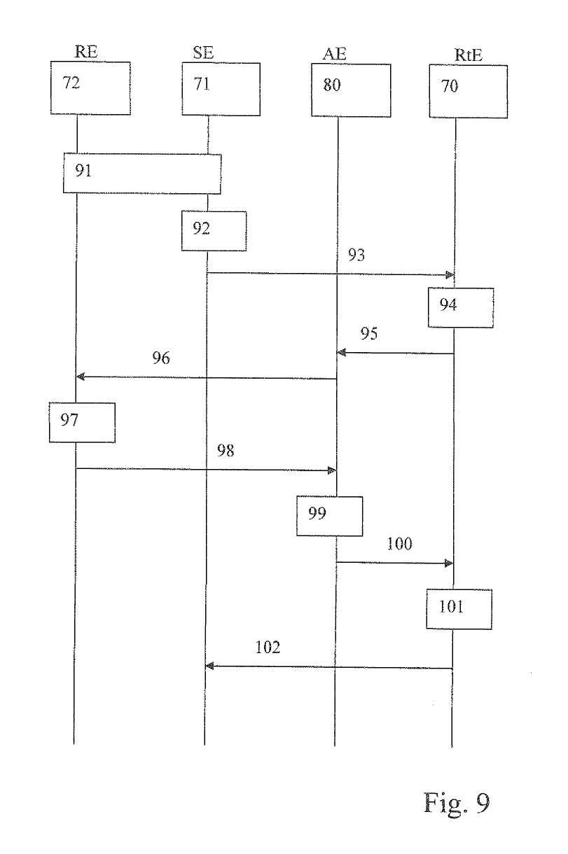

A basic example showing procedures and signalling for a plurality of the previously described entities will be described in connection with FIG. 9. In FIG. 9 reference numeral 70 refers to a rating entity, reference numeral 71 to a service entity (such as e.g. an entity for providing a TV service), reference numeral 72 to a resource entity (e.g. a server holding the actual TV content) and reference numeral 80 refers to the dedicated agent entity. When a user requests or receives a service that is chargeable, the service entity will collect information it deems necessary for the event, before it sends such information to the rating entity for triggering and enabling a charging procedure. In accordance with a concept of the invention, the rating trigger message will include information that allows the rating entity to derive a reference, e.g. the trigger message will comprise a link or some other pointer to a location from where the information being sent is located. For example, a service entity 71 may simply add the URL of the resource entity 72 from which specific information being sent within the rating trigger message was obtained. This information may be specific for a user and/or event, and therefore might also contain indications for a specific time or for a specific version. The rating entity will then typically perform a rating operation using the information received from the service entity, but is also capable of performing a procedure for sending a request for service related information to the dedicated agent entity to fetch more information.

More specifically, as shown in the example of FIG. 9, reference numeral 91 indicates that the service entity 71 and the resource entity (or resource entities) 72 exchange information, in order to provide resources for serving a user. Reference numeral 92 indicates that the service entity 71 decides if the event is chargeable, and if so, collects information it deems useful or necessary for performing rating/charging. Reference numeral 93 indicates a message sent by the service entity 71 to the rating entity 70, which contains the gathered information, and in accordance with a concept of the invention, information that allows the rating entity 70 to derive a reference for possibly obtaining further information.

Reference numeral 94 indicates that the charging system 70 will start rating based on the received information, and to determine if it possibly desires further information. If so, it can derive the reference towards a destination entity (e.g. a resource entity) from the received rating trigger message, and may make a decision for selecting which information it would like to receive. Reference numeral 95 indicates that the rating entity 70 sends a request for further service related information to the dedicated agent entity 80. In response thereto, agent entity 80 sends a message 96 to the destination entity, which in the example of FIG. 9 is resource entity 72. In the example, resource entity 72 holds information that the rating entity 70 desires for performing the rating operation. Reference numeral 97 indicates resource entity's 72 operation for collecting information in response to the query or request message. Reference numeral 98 indicates the response from resource entity 72 that contains information of data indicated in the request from the dedicated agent entity.

The example of FIG. 9 shows that agent entity 80 performs a transformation operation 99 for restructuring/reformatting information from the message 98, in order to be able to send an appropriate response 100 to the rating entity 70. The rating entity then continues its rating in operation 101 using the additional information received in message 100. It is noted that in case that the information received in message 100 is deemed to still be insufficient, that rating entity 70 preferably is able to repeat the basic mechanism of sending a request for additional service related information to the dedicated agent entity, see steps 95-100, preferably with a modified set of information that is asked for.

Finally, the rating entity 70 may send a message 102 as a response to the rating trigger message 93 to service entity 71, e.g. comprising the result of the rating procedure, i.e. a cost for the service, or also providing other information, such as whether or not the users account has sufficient funds, etc.

The present invention has been described by making reference to specific embodiments above. However, it is noted that this description of embodiments only serves to provide a better understanding, but is by no means to be seen as limiting for the invention, which is defined by the appended claims. Furthermore, reference signs in the claims are only for information purposes and also have no limiting effect.

1. A method for controlling an agent entity for a service providing network, the method comprising:
receiving a request for service related information from a rating entity, said request comprising a reference relating to a service provision action;
performing a data procurement operation towards a destination entity in response to said reference;
receiving procured data from said destination entity responsive to the data procurement operation; and
extracting one or more pieces of information from said procured data for sending to said rating entity in response to said request for service related information.

2. The method of claim 1, said service providing network comprising:
service entities and resource entities, said service entities being arranged for procuring resources from said resource entities for providing service to users, a predetermined interface protocol being defined between said service entities and resource entities, wherein said destination entity is a resource entity, and
wherein performing said data procurement operation comprises using said predetermined interface protocol for accessing said destination entity.

3. The method of claim 2, said predetermined interface protocol being a first interface protocol and said service entities being arranged for communicating with said rating entity according to a second predetermined interface protocol, wherein communication between said agent entity and said rating entity is performed according to said second predetermined interface protocol.

4. The method of claim 1, wherein said reference comprises a Uniform Resource Locator associated with said destination entity.

5. The method of claim 1, wherein said reference comprises an indicator related to a resource associated with said service provision action.

6. The method of claim 1, wherein said procured data is of a first type, and said extracting comprises generating said one or more pieces of information as data of a second type different from said first type.

7. A method of controlling a rating entity for a service providing network, the method comprising:
performing a rating operation in response to receiving at the rating entity a rating trigger message from a service entity,
determining from said rating trigger message a reference to service related information related to a service for which said rating operation is to be performed, and
requesting desired information in response to said reference using an information request procedure that sends a request for service related information to a dedicated agent entity.

8. The method of claim 7, further comprising determining whether first service related information that is present at said rating entity is sufficient for said rating operation, and if in response to when said first service related information is determined to be insufficient, performing the request for said desired information as second service related information.

9. The method of claim 8, wherein said first service related information is determined from said rating trigger message.

10. A computer program product comprising a computer program for performing the method of claim 1 when executed on a programmable entity of a service providing network.

11. An agent entity for a service providing network, the agent entity comprising:
a request receiver for receiving a request for service related information from a rating entity, said request comprising a reference relating to a service provision action;
a data procurer for performing a data procurement operation towards a destination entity in response to said reference;
a data receiver for receiving procured data from said destination entity; and
a data extractor for extracting one or more pieces of information from said procured data for sending to said rating entity in response to said request for service related information.

12. A rating entity for a service providing network, said rating entity comprising:
a service rater for receiving a rating trigger message from a service entity and performing a rating procedure in response thereto,
wherein said service rater is arranged to determine from said rating trigger message a reference to data related to a service for which said rating procedure is to be performed, and to perform a request procedure for procuring desired information on the basis of said reference, said request procedure comprising sending a request for service related information to a dedicated agent entity of said service providing network.

13. A method of service rating in a service providing network, the method comprising:
performing, by a service entity, a service provision action towards a user, and sending a rating trigger message to a rating entity;
determining, by the rating entity, from said rating trigger message a reference to service related information related to said service provision action
sending, by the rating entity, a request for service related information to a dedicated agent entity of said service providing network, said request comprising said reference;
performing, by the dedicated agent entity, a data procurement operation towards a destination entity on the basis of said reference;
sending, by the destination entity, response data to said dedicated agent entity; and
extracting, by the dedicated agent entity, one or more pieces of information from said response data and sending said one or more pieces of information to said rating entity as a response to said request for service related information.
